(19) United States
(12) Patent Application Publication
(10) Pub. No.: US 2011/0015778 A1
(43) Pub. Date: Jan. 20, 2011

(54) DATA CARTRIDGE AND TAPE LIBRARY INCLUDING FLASH MEMORY

(75) Inventors: Dwayne A. Edling, Longmont, CO (US); Mark L. Watson, Louisville, CO (US); Michael J. Cornwell, San Jose, CA (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: ORACLE INTERNATIONAL CORPORATION, Redwood City, CA (US)

(21) Appl. No.: 12/831,441

(22) Filed: Jul. 7, 2010

Related U.S. Application Data
(63) Continuation of application No. 12/433,307, filed on Apr. 30, 2009.

(51) Int. Cl. G06F 7/00; G06F 12/00; G06F 12/14

(52) U.S. Cl. 700/214; 711/103; 711/E12.001; 711/E12.091

(57) ABSTRACT

A data storage system for use with a plurality of tape cartridges is provided. Each tape cartridge includes a length of tape media and an amount of flash memory. The data storage system includes a tape cartridge library having a plurality of storage cells. Each storage cell is configured to store a tape cartridge. The tape cartridge library further includes a plurality of tape drives. Each tape drive is configured to access a tape cartridge when the tape cartridge is received in the tape drive. The system further includes a robotic tape mover and a flash memory access mechanism. The robotic tape mover moves tape cartridges between the plurality of storage cells and the plurality of tape drives. The flash memory access mechanism is configured in the tape cartridge library to access the flash memory of a tape cartridge when the tape cartridge is in the tape cartridge library.

### CROSS-REFERENCE TO RELATED APPLICATIONS

This application is a continuation of U.S. application Ser. No. 12/433,307 filed Apr. 30, 2009. The disclosure of which is incorporated in its entirety by reference herein.

### TECHNICAL FIELD

The invention relates to data storage cartridges and tape libraries.

### BACKGROUND

The amount of digital data being created annually is increasing. It has been estimated that 5 EB of digital data were created in 2002, 161 EB of digital data were created in 2006, and 281 EB of digital data were created in 2007. It is projected that at least 1,773 EB of digital data will be created in 2011. Of this vast quantity of data, it is predicted that some 35% (600+ EB) will need to be safely preserved (archived) for ten years or more. This will inevitably result in very substantial costs for both the storage equipment required and the power needed to store the data for extended periods. Simply anticipating that it will be practical, and perhaps even feasible, to store these vast quantities of digital data on rigid disk (HDD) for extended periods is highly problematic.

A simple analysis, based on published data, reveals firstly that even with spinning down archival HDDs to idle mode it will still cost at least a billion dollars per year to store 600 EB of data. Secondly, it will be challenging for the HDD industry to produce sufficient high capacity, enterprise class drives on which to store this data. The cost of these HDDs alone could approach 50 billion dollars. Finally, the irrecoverable read error rate of rigid disk drives is today specified as one error per 10¹⁵ bits read. Hence, without implementing additional data protection schemes such as dual parity RAID or more advanced error correction codes (ECC), with the inevitable increase in data storage overhead, these error rates will potentially result in data corruption during either a RAID re-build, or the necessary migration of data from one HDD sub-assembly to an upgraded system, or even during normal access over the extended lifetimes of the archived data.

In contrast, storing vast quantities of archival data on tape storage systems will continue to be the most cost effective, in terms of both cost per TB and power use, and practical long term solution for the foreseeable future. Tape storage areal densities have been growing at greater than 40% compound annual growth rate in recent years and it is today feasible to store many TB of data on a single data cartridge containing some 1,000 m of tape.

However, storing these or greater quantities of data on a single cartridge presents several issues to the archival system. It takes time to access the data as each tape load is very time consuming and affects the reliability of the cartridge and tape drive. The speed that data can be written to and read from a single tape drive is limited by the data rate of that drive, and during this process data stored elsewhere on the cartridge is not available to the host system. Structuring the data, for example, through the use of associated metadata is impractical, and requires the use of an external independent file system. Additionally, updating metadata on a sequential access device can be problematic and may require rewriting user data that has not been modified.

In addition to the above problems there is also a performance issue that needs to be addressed in high performance computing (HPC) environments. Storing large amounts of digital data on a single data cartridge presents several major technical issues. It can take time to access the data and to write the data to a single drive which is highly problematic for large data sets such as those routinely used in the high performance computing (HPC) environment. During this process, data stored elsewhere on the cartridge is not available. In many HPC applications, vast quantities of data must be cached before application computing can start. In these environments, it often takes days, or even weeks, to download the computational data set. The bottleneck in this environment is the speed that a single tape drive can transfer data. Providing the ability to stripe a data set across several cartridges, which could be accessed in parallel, would increase the performance as a multiple of how many tape cartridges were assigned to the data set. This high performance configuration would be ideal for many HPC applications that now take days to stage data.

Finally, the need to manage archive data cost effectively requires the ability to have policy driven tiered storage management in which the metadata is stored with the files being archived.

For the foregoing reasons, there is a need for an improved data storage cartridge and tape library.

### SUMMARY

It is an object of the invention to provide an improved data storage cartridge and tape library.

In one embodiment of the invention, a data storage system is provided. The data storage system comprises a tape cartridge library. The tape cartridge library includes a plurality of storage cells. Each storage cell is configured to store a tape cartridge. The tape cartridge library further includes a plurality of tape drives. Each tape drive is configured to access a tape cartridge when the tape cartridge is received in the tape drive. The data storage system further comprises a plurality of tape cartridges in the tape cartridge library. Each tape cartridge includes a length of tape media and an amount of flash memory.

A robotic tape mover is provided for moving tape cartridges between the plurality of storage cells and the plurality of tape drives. The robotic tape mover may also be used for loading cartridges into the library and positioning them in the correct slots. A flash memory access mechanism such as a serial or parallel electrical connection, wireless connection, or other physical interface is configured in the tape cartridge library to access the flash memory of received cartridges at the plurality of tape drives and to access the flash memory of stored cartridges at the plurality of storage cells. The flash memory access mechanism may be located on an arm of the robotic tape mover.

It is appreciated that the flash memory access mechanism may be configured in a variety of ways. The flash memory access mechanism may be configured to access the flash memory of received cartridges at the plurality of tape drives when a received cartridge is loaded into a tape drive. The flash memory access mechanism may be configured to access the flash memory of stored cartridges at the plurality of storage cells when a stored cartridge is at rest in a storage cell. The flash memory access mechanism may include a wireless access device, or may include a wired access device.

In another embodiment of the invention, a data storage system for use with a plurality of tape cartridges, each tape cartridge including a length of tape media and an amount of flash memory, is provided. The data storage system comprises a tape cartridge library including a plurality of storage cells. Each storage cell is configured to store a tape cartridge. The tape cartridge library further includes a plurality of tape drives. Each tape drive is configured to access a tape cartridge when the tape cartridge is received in the tape drive.

A robotic tape mover is provided for moving tape cartridges between the plurality of storage cells and the plurality of tape drives. A flash memory access mechanism is configured in the tape cartridge library to access the flash memory of a tape cartridge when the tape cartridge is in the tape cartridge library. The flash memory access mechanism may be configured in a variety of ways.

Still further, the invention comprehends a tape cartridge for use in a data storage system. The tape cartridge comprises a housing, a length of tape media contained in the housing for storing data, and an amount of flash memory attached to the housing. An amount of flash memory greater than 1 GB is suitable in some embodiments of the invention.

### BRIEF DESCRIPTION OF THE DRAWINGS

FIG. 1 illustrates a data storage system in an embodiment of the invention;

FIG. 2 illustrates a tape cartridge in an embodiment of the invention;

FIG. 3 illustrates a method of operating a data storage system in an embodiment of the invention;

FIG. 4 illustrates a method of operating a data storage system, including striping data across tape media, in an embodiment of the invention;

FIG. 5 illustrates a method of operating a data storage system, including performing data deduplication, in an embodiment of the invention;

FIG. 6 illustrates a method of operating a data storage system, including controlling access to stored data, in an embodiment of the invention;

FIG. 7 illustrates a method of operating a data storage system, including preventing over-writing or deletion of at least a portion of stored metadata, in an embodiment of the invention; and

FIG. 8 illustrates a method of operating a data storage system, including performing an audit, in an embodiment of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In one embodiment of the invention, flash memory is embedded in a tape data cartridge to enable significant amounts of metadata to be written and accessed both when the cartridge is at rest in a data storage system (for example, in a tape library) and when the cartridge is loaded into the tape drive. Appropriate connectivity to access the flash memory in both the tape drive and in the storage cell of the library is provided with the tape library. In an alternative, data may be read from or written to the flash memory while a cartridge is being inserted or removed from the library, or inserted or removed from a library slot. The flash memory access mechanism may be a serial or parallel electrical connection, wireless connection, or other physical interface. The flash memory access mechanism may be located on the arm of the robotic tape mover. The robotic tape mover moves tape cartridges between the tape drives and the storage cells, and may load cartridges into the library and position them in the current slots.

It is appreciated that the overall system architecture may vary depending on the implementation. For example, access by the host application to the flash memory may be provided in any suitable way. As well, the particular connection to the flash memory may take any appropriate form such as, for example, known wireless communication approaches (WIFI) or known wired approaches (USB, SCSI).

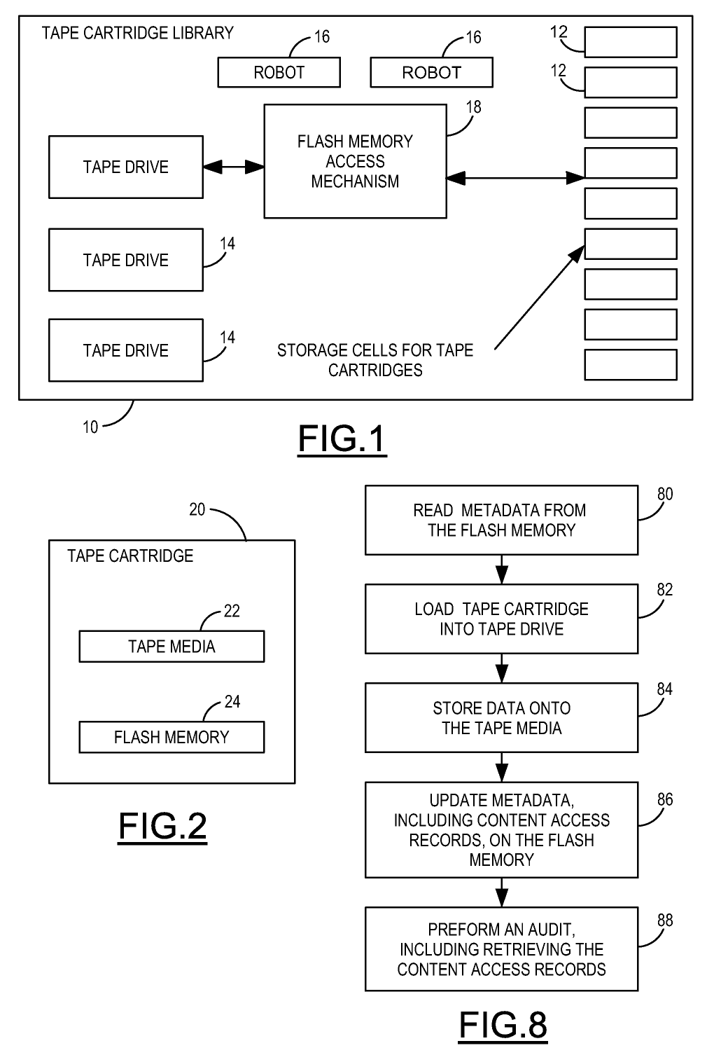

FIG. 1 illustrates a data storage system in an embodiment of the invention. The data storage system includes a tape cartridge library 10. Tape cartridge library 10 includes a plurality of storage cells 12. Each storage cell 12 is configured to store a tape cartridge, generally in a known manner. Tape cartridge library 10 further includes a plurality of tape drives 14. Each tape drive 14 is configured to access a tape cartridge when the tape cartridge is received in the tape drive 14, generally in a known manner. A plurality of robotic tape movers 16 are provided in tape cartridge library 10 for moving tape cartridges between the plurality of storage cells 12 and the plurality of tape drives 14, generally in a known manner.

FIG. 2 illustrates a tape cartridge 20 in an embodiment of the invention. Tape cartridge 20 includes a length of tape media 22, and an amount of flash memory 24. A plurality of tape cartridges 20 are included in tape cartridge library 10.

With continuing reference to FIG. 1, a flash memory access mechanism 18 is configured in tape cartridge library 10. Flash memory access mechanism 18 is configured to access the flash memory 24 of received cartridges 20 at the plurality of tape drives 14 and to access the flash memory 24 of stored cartridges 20 at the plurality of storage cells 12.

The inclusion of the flash memory 24 in the data cartridge 20 has many advantages. For example, current performance limitations in HPC environments are addressed by allowing the association of formatting information across multiple data cartridges. This information can then be used to intelligently stripe data across a set of data cartridges, thereby significantly increasing the data rate to and from the library. In this environment, the application will know where all the data is located, both physically and logically, and has access to several GB of metadata and format information for each cartridge. Thus, a set of data cartridges can be simultaneously accessed by a corresponding set of tape drives, each running at up to several hundred MB/s. Hence, the aggregate data rate for the system would easily match the data rate of any foreseeable HPC back-bone.

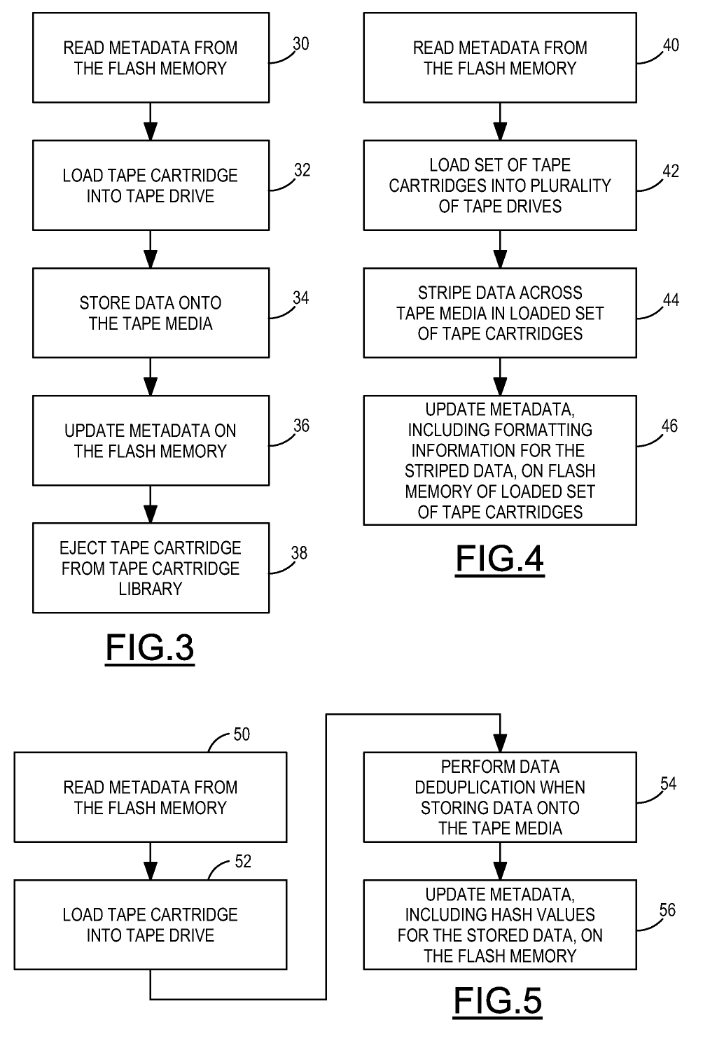

FIGS. 3 and 4 illustrate methods of operating a data storage system in an embodiment of the invention. As shown in FIG. 3, at block 30, metadata is read from the flash memory. At block 32, a tape cartridge is loaded into a tape drive. At block 34, data is stored onto the tape media in the loaded tape cartridge. At block 36, metadata corresponding to the stored data is updated on the flash memory of the loaded tape cartridge. At block 38, the tape cartridge is ejected from the tape cartridge library. Advantageously, embodiments of the invention may allow for reading of metadata on the tape slots, without loading tape cartridges. It may be possible for a host to read all metadata from all tapes without loading the tapes. As well, it may be possible for the robotic tape mover to read metadata as a cartridge is loaded into the library. As shown in FIG. 4, at block 40, metadata is read from the flash memory. At block 42, a set of tape cartridges is loaded into the plurality of tape drives. At block 44, data is striped across the tape media in the loaded set of tape cartridges. At block 46, metadata corresponding to the striped data is updated on the flash memory of the loaded set of tape cartridges. The metadata includes formatting information for the striped data.

Business continuity and availability for an archive system is critical to help ensure that any failures in the archive system do not result in loss of data. By intelligently striping the content of a given data set, and providing distributed parity across several independent data cartridges, significant protection against such potential data loss or corruption may be provided. In addition, data cartridges can be very simply and easily removed from the library for transport to a remote facility where, once loaded into the remote system, the entire content of the cartridge metadata can be very quickly accessed. Hence, system level mirroring and replication for long term storage can be very easily accomplished as a background task. This allows search and index engines to use this highly portable metadata in a model that is independent of database, operating or file system limitations associated with storing metadata information on a server.

The ability to persistently store the metadata associated with the content of a cartridge also greatly facilitates data deduplication. Data deduplication is a method of reducing storage requirements by eliminating redundant data and only storing one unique instance of a data unit (bit, byte or file) on a storage medium such as a tape cartridge. Deduplication technology identifies variable-length blocks of data across various files and file types and then stores unique blocks once, replacing redundant blocks with data pointers. When an incoming data block is a duplicate of something that has already been stored, the block is not stored again. Each portion of ingested data is processed using a hash algorithm which generates a unique number for that piece of data which is then stored in an index. If a file is updated, only the changed data is saved, thus avoiding the necessity for storing an entirely new file. Although highly efficient in terms of storage capacity, data deduplication can result in very large indexes creating scalability issues as the data deduplication system grows. In embodiments of the invention, the persistent flash memory embedded in the data cartridge may be utilized to store the relevant indexes for the updated data fragments written in the content of the cartridge. Thus, the host system will be able to simultaneously write deduplicated data to many drives in parallel and keep track of the indices for each cartridge in the entire library while doing this. Data indexing and metadata are also important not only in establishing a mechanism for locating information at a later date, but for exposing the appropriate content and context for application of the relevant established business data access policies.

FIG. 5 illustrates a method of operating a data storage system, including performing data deduplication, in an embodiment of the invention. At block 50, metadata is read from the flash memory. At block 52, a tape cartridge is loaded into a tape drive. At block 54, data is stored onto the tape media in the loaded tape cartridge and data deduplication is performed when storing the data. In more detail, for deduplication, a hash is generated on each object. If this value matches a previously generated and stored hash value for a different object then this object is a duplicate. For deduplication management, the hash values and pointers or links to the objects that match the hash value are stored with the metadata in the flash memory. At block 56, metadata corresponding to the stored data is updated on the flash memory of the loaded tape cartridge. The metadata includes hash values corresponding to the stored data.

Policy binding, through the use of metadata stored in the embedded flash memory in each data cartridge, may securely limit the access to the content of each file contained on that data cartridge. Additionally, it will be possible to provide encryption of the content stored on the data cartridge independently from the metadata associated with this content which will be stored in the persistent flash memory in the same data cartridge. Hence, the archival storage system will be able to discern the nature of the content contained on a given data cartridge, but without access to the necessary encryption keys will be unable to read the content of the data. To aid in addressing compliance requirements, an archive system must also prevent unauthorized access, modification, or deletion of documents.

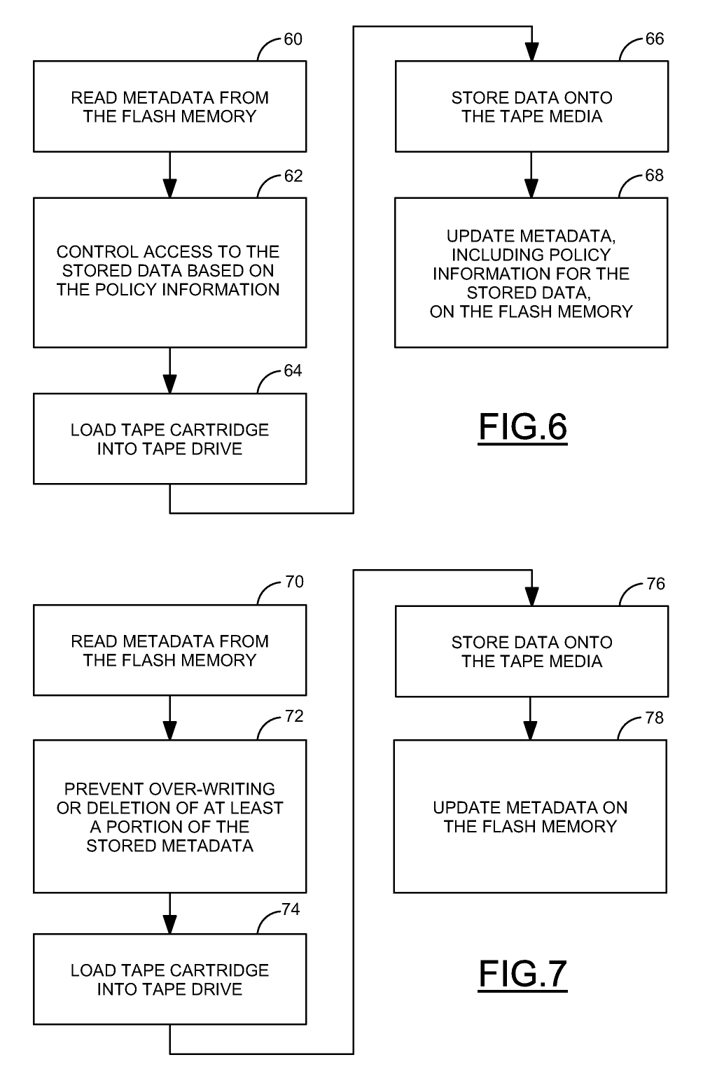

FIG. 6 illustrates a method of operating a data storage system, including controlling access to stored data, in an embodiment of the invention. At block 60, metadata is read from the flash memory. The metadata includes policy information for the stored data, and, at block 62, access to the stored data is controlled based on the policy information. At block 64, a tape cartridge is loaded into a tape drive. At block 66, data is stored onto the tape media in the loaded tape cartridge. At block 68, metadata including policy information corresponding to the stored data is updated on the flash memory of the loaded tape cartridge.

By appropriately configuring the flash memory controller contained in the data cartridge, it will be possible to prevent over-writing, or deletion of the metadata stored on a given data cartridge. In addition, the proposed system will facilitate data protection through the use of write once, read many times (WORM) data cartridges based on both magnetic tape storage and optical tape storage technologies. The use of embedded persistent flash memory may also enable a detailed record of content access to be maintained. This may provide definitive information to the system for audit-logging and documentation purposes. With the significant increase in tape based storage areal data densities recently demonstrated, it will be feasible to shorten the length of the tape in the data cartridge while still providing at least one TB cartridge capacity.

FIGS. 7 and 8 illustrate methods of operating a data storage system in an embodiment of the invention. As shown in FIG. 7, at block 70, metadata is read from the flash memory. At block 72, over-writing or deletion of at least a portion of the stored metadata is prevented. At block 74, a tape cartridge is loaded into a tape drive. At block 76, data is stored onto the tape media in the loaded tape cartridge. At block 78, metadata corresponding to the stored data is updated on the flash memory of the loaded tape cartridge. As shown in FIG. 8, at block 80, metadata is read from the flash memory. At block 82, a tape cartridge is loaded into a tape drive. At block 84, data is stored onto the tape media in the loaded tape cartridge. At block 86, metadata corresponding to the stored data is updated on the flash memory of the loaded tape cartridge. The metadata includes content access records. At block 88, an audit is performed. The audit includes retrieving the content access records.

The need to manage archive data cost effectively also requires the ability to have policy-driven tiered storage management in which the metadata is stored with the files being archived. Embodiments of the invention provide the ability to update metadata without tape access, and have the metadata physically stored with the tape cartridge.

Advantageously, using such an approach, a sizeable (many TB) flash cache is now available to the file system which can use it to intelligently and efficiently drain the file content to the tape archive medium according to established archive policies.

In yet another advantage, embodiments of the invention may provide standardization of an open format for both the physical and logical interfaces of the cartridge, together with backward read capability over several generations of data cartridges which may enable, and protect, the archival nature of the stored data. This will also facilitate any transition to new storage devices and technologies as they become available.

In some embodiments of the invention, the library may become a very large, fast access, intelligent storage repository, which can be flexibly expanded and provisioned as necessary (by simply adding more cartridge slots). For example, embodiments of the invention may be employed in a data storage system that utilizes an object based, parallel file system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A data storage system comprising:
a tape cartridge library including a plurality of storage cells, each storage cell being configured to store a tape cartridge, the tape cartridge library further including a plurality of tape drives, each tape drive being configured to access a tape cartridge when the tape cartridge is received in the tape drive;
a plurality of tape cartridges in the tape cartridge library, each tape cartridge including a length of tape media and an amount of flash memory;
a robotic tape mover for moving tape cartridges between the plurality of storage cells and the plurality of tape drives; and
a flash memory access mechanism configured in the tape cartridge library to access the flash memory of received cartridges at the plurality of tape drives and to access the flash memory of stored cartridges at the plurality of storage cells.

2. The data storage system of claim 1 wherein the flash memory access mechanism is configured to access the flash memory of received cartridges at the plurality of tape drives when a received cartridge is loaded into a tape drive.

3. The data storage system of claim 1 wherein the flash memory access mechanism is configured to access the flash memory of stored cartridges at the plurality of storage cells when a stored cartridge is at rest in a storage cell.

4. The data storage system of claim 1 wherein the flash memory access mechanism comprises a wireless access device.

5. The data storage system of claim 1 wherein the flash memory access mechanism comprises a wired access device.

6. A data storage system for use with a plurality of tape cartridges, each tape cartridge including a length of tape media and an amount of flash memory, the data storage system comprising:
a tape cartridge library including a plurality of storage cells, each storage cell being configured to store a tape cartridge, the tape cartridge library further including a plurality of tape drives, each tape drive being configured to access a tape cartridge when the tape cartridge is received in the tape drive;
a robotic tape mover for moving tape cartridges between the plurality of storage cells and the plurality of tape drives; and
a flash memory access mechanism configured in the tape cartridge library to access the flash memory of a tape cartridge when the tape cartridge is in the tape cartridge library.

7. The data storage system of claim 6 wherein the flash memory access mechanism is configured to access the flash memory of received cartridges at the plurality of tape drives when a received cartridge is loaded into the tape drive.

8. The data storage system of claim 6 wherein the flash memory access mechanism is configured to access the flash memory of stored cartridges at the plurality of storage cells when a stored cartridge is at rest in a storage cell.

9. The data storage system of claim 6 wherein the flash memory access mechanism is configured to access the flash memory of a cartridge when the cartridge is held by the robotic tape mover.

10. The data storage system of claim 6 wherein the flash memory access mechanism comprises a wireless access device.

11. The data storage system of claim 6 wherein the flash memory access mechanism comprises a wired access device.

12. A method of operating the data storage system of claim 6, the method comprising:
loading a tape cartridge into a tape drive;
storing data onto the tape media in the loaded tape cartridge; and
storing metadata corresponding to the stored data onto the flash memory of the loaded tape cartridge.

13. The method of claim 12 further comprising:
ejecting the tape cartridge from the tape cartridge library, whereby metadata stored onto the flash memory stays with the tape cartridge after ejection.

14. A method of operating the data storage system of claim 6, the method comprising:
loading a set of tape cartridges into the plurality of tape drives;
striping data across the tape media in the loaded set of tape cartridges; and
storing metadata corresponding to the striped data onto the flash memory of the loaded set of tape cartridges, the metadata including formatting information for the striped data.

15. A method of operating the data storage system of claim 6, the method comprising:
reading metadata from the flash memory of a tape cartridge, the metadata including hash values for stored data on the tape media of the tape cartridge;
loading the tape cartridge into a tape drive;
storing data onto the tape media in the loaded tape cartridge, including performing data deduplication based on the hash values; and
updating metadata corresponding to the stored data on the flash memory of the loaded tape cartridge, as needed.

16. A method of operating the data storage system of claim 6, the method comprising:
reading metadata from the flash memory of a tape cartridge, the metadata including policy information for stored data on the tape media of the tape cartridge; and
controlling access to the stored data based on the policy information.

17. A method of operating the data storage system of claim 6, the method comprising:
reading metadata from the flash memory of a tape cartridge;
loading the tape cartridge into a tape drive;
storing data onto the tape media in the loaded tape cartridge;
updating metadata corresponding to the stored data on the flash memory of the loaded tape cartridge; and
preventing over-writing or deletion of at least a portion of the stored metadata.

18. A method of operating the data storage system of claim 6, the method comprising:
reading metadata from the flash memory of a tape cartridge;
loading the tape cartridge into a tape drive;
storing data onto the tape media in the loaded tape cartridge;
updating metadata corresponding to the stored data on the flash memory of the loaded tape cartridge, wherein the metadata includes content access records; and
performing an audit, including retrieving the content access records.

19. A method of operating the data storage system of claim 6, the method comprising:
storing metadata onto the flash memory of a tape cartridge while the tape cartridge is stored in a storage cell.

20. A tape cartridge for use in a data storage system, the tape cartridge comprising:
a housing;
a length of tape media contained in the housing for storing data; and
an amount of flash memory, greater than 1 GB, attached to the housing.
